(19) United States
(12) Patent Application Publication
(10) Pub. No.: US 2025/0279540 A1
(43) Pub. Date: Sep. 4, 2025

(54) SEPARATOR FOR LITHIUM SECONDARY BATTERY, LITHIUM SECONDARY BATTERY INCLUDING SAME, AND METHOD FOR PREPARING SEPARATOR FOR LITHIUM SECONDARY BATTERY

(71) Applicant: Samsung SDI Co., Ltd., Yongin-si, Gyeonggi-do (KR)

(72) Inventors: Daehyun Hong, Yongin-si (KR); Seungmin Yu, Yongin-si (KR); Woosung Lee, Yongin-si (KR)

(21) Appl. No.: 18/555,236

(22) PCT Filed: Apr. 5, 2022
(86) PCT No.: PCT/KR2022/004863

§ 371 Date: Jan. 19, 2024

(30) Foreign Application Priority Data
Apr. 16, 2021 (KR) 10-2021-0050016

(51) Int. Cl. H01M 50/403; H01M 10/052; H01M 50/429; H01M 50/431; H01M 50/446; H01M 50/449

(52) U.S. Cl. CPC H01M 50/403; H01M 50/4295; H01M 50/431; H01M 50/446; H01M 50/449; H01M 10/052

(57) ABSTRACT

Provided are a separator for a lithium secondary battery, a lithium secondary battery including the same, and a method of preparing the separator for a lithium secondary battery. The separator for a lithium secondary battery includes: a substrate; a first layer disposed on a surface of the substrate and consisting of inorganic particles; and a second layer disposed on the first layer and consisting of polymer binder particles, wherein an average particle diameter of the inorganic particles is less than 300 nm, and an average particle diameter of the polymer binder particles is 200 nm to 500 nm. The separator, due to reduced surface roughness and improved packing density of the first layer consisting of the inorganic particles, may have a uniform coating. The lithium secondary battery including the separator may have improved adhesion between the separator and electrodes, and thus the lithium secondary battery may have improved bending strength.

### TECHNICAL FIELD

The present disclosure relates to a separator for a lithium secondary battery, a lithium secondary battery including the same, and a method of preparing the separator for a lithium secondary battery.

### BACKGROUND ART

Separators for electrochemical batteries not only serve as interposed membranes that isolate a positive electrode and a negative electrode from each other in a battery and continuously maintain ionic conductivity to enable charging and discharging of the battery, but also prevent short circuits.

Generally used substrates, such as polyolefin-based fabrics, are prone to heat shrinkage at high temperatures and have poor physical durability. Accordingly, when abnormalities occur and the internal temperature in a battery rises, separators are prone to deformation and, in severe cases, may explode. In order to improve heat resistance and safety of separators, the development of coated separators in which inorganic particles and a binder are coated in a single layer or double layers on a substrate is in progress.

However, when a substrate is coated with inorganic particles and a binder simultaneously and consecutively in two layers, a uniform coating of a binder slurry which is in an aqueous solution state is difficult to carry out on a wet coating layer of inorganic particles.

Therefore, there is still a need for a separator for a lithium secondary battery, having improved adhesion between the separator and electrodes by implementing a uniform coating between a first layer including inorganic particles and a second layer including polymer binder particles, resulting in improved bending strength, a lithium secondary battery including the separator, and a method of preparing the separator for a lithium secondary battery.

### DISCLOSURE

### Technical Problem

One aspect provides a separator for a lithium secondary battery, in which a first layer including inorganic particles has reduced surface roughness and improved packing density, enabling a uniform coating.

Another aspect provides a lithium secondary battery with enhanced bending strength by improving adhesion between the separator and electrodes by including the separator.

Another aspect provides a method of preparing the separator for a lithium secondary battery.

### Technical Solution

According to one aspect, a separator for a lithium secondary battery includes:
a substrate;
a first layer disposed on at least one surface of the substrate and including inorganic particles, and
a second layer disposed on the first layer and including polymer binder particles, wherein
an average particle diameter (D50) of the inorganic particles is less than 300 nm, and an average particle diameter (D50) of the polymer binder particles is about 200 nm to about 500 nm.

A thickness of the first layer may be 1.5 μm to 4.0 μm.

A thickness of the second layer may be 1.0 μm to 3.0 μm.

A surface roughness (Ra) of the first layer may be 70 nm or less.

The polymer binder particles of the second layer that have penetrated into the inorganic particles of the first layer may penetrate to a depth of 0.5 μm or less in a direction of the substrate from an interface between the first layer and the second layer.

The inorganic particles may include at least one selected from alumina (Al₂O₃), boehmite, BaSO₄, MgO, Mg(OH)₂, clay, silica (SiO₂), TiO₂, SnO₂, CeO₂, NiO, CaO, ZnO, ZrO₂, Y₂O₃, SrTiO₃, BaTiO₃, and MgF₂.

The polymer binder particles may include an acrylate-based binder, a fluorine-based binder, a rubber-based binder, a cellulose-based binder, or a combination thereof.

According to another aspect, a lithium secondary battery includes:
a positive electrode including a positive electrode active material;
a negative electrode including a negative electrode active material; and
the aforementioned separator disposed between the positive electrolyte and the negative electrode.

A bending strength of the lithium secondary battery may be 400 N or more.

According to another aspect, a method of preparing the separator for a lithium secondary battery includes:
preparing a substrate;
preparing a first composition including inorganic particles having an average particle diameter (D50) of less than 300 nm;
preparing a second composition including polymer binder particles having an average particle diameter (D50) of 200 nm to 500 nm;
forming a first layer including the inorganic particles by coating at least one surface of the substrate with the first composition; and
forming a second layer including the polymer binder particles by coating one surface of the first layer with the second composition and drying the same to thereby prepare the aforementioned separator for a lithium secondary battery.

A solids content in the first composition may be 40 wt % to 50 wt % based on a total of 100 wt %.

A surface roughness Ra of the first layer may be 70 nm or less.

A thickness of the first layer may be 1.5 μm to 4.0 μm, and a thickness of the second layer may be 1.0 μm to 3.0 μm.

### Advantageous Effects

A separator for a lithium secondary battery according to one aspect includes: a substrate; a first layer disposed on at least one surface of the substrate and including inorganic particles; and a second layer disposed on the first layer and including polymer binder particles, wherein an average particle diameter (D50) of the inorganic particles is less than 300 nm, and an average particle diameter (D50) of the polymer binder particles is 200 nm to 500 nm. The separator for a lithium secondary battery may be uniformly coated since the first layer including the inorganic particles has reduced surface roughness Ra and improved packing density. A lithium secondary battery including the separator may have improved adhesion between the separator and electrodes, resulting in improved bending strength.

### DESCRIPTION OF DRAWINGS

FIG. 1 is a schematic view of a lithium secondary battery according to an embodiment.

FIG. 2 is a field emission-scanning electron microscope (FE-SEM) image obtained from a cross section of a separator prepared in Example 1.

FIG. 3 is a schematic diagram showing the standard for a battery sample size measured by using a 3-point bending tester when measuring bending strength according to Evaluation Example 2.

### BEST MODE

### Mode for Invention

Hereinafter, a separator for a lithium secondary battery, a lithium secondary battery including the same, and a method of preparing the separator for a lithium secondary battery will be described in detail with reference to Examples and Drawings of the present disclosure. These examples are only presented by way of example to explain the present disclosure in more detail, and it will be apparent to those skilled in the art that the scope of the present disclosure is not limited by these examples.

Unless otherwise defined, all technical and scientific terms used in the present specification have the same meaning as commonly understood by those skilled in the art to which the present disclosure belongs to. In case of conflict, the present specification including definitions is considered in priority.

Although methods and materials similar or equivalent to those described herein can be used in the practice or testing of the present disclosure, suitable methods and materials are described herein. An expression used in the singular encompasses the expression of the plural, unless it has a clearly different meaning in the context.

It will be further understood that the terms “comprises” or “includes” when used in the present specification, specify the presence of stated features, regions, integers, steps, operations, elements, and/or components, but do not preclude the presence or addition of one or more other features, regions, integers, steps, operations, elements, components, and/or groups thereof.

The term “a combination thereof” as used herein means a mixture or combination of one or more of the aforementioned elements.

The term “and/or” as used herein is meant to include any and all combinations of one or more of the items listed in relation thereto. The term “or” as used herein means “and/or”. The expression “at least one” or “one or more” used in front of components in the present specification is meant to supplement a list of all components means, and does not imply to supplement individual components of the description.

In the drawings, thicknesses may be magnified or exaggerated to clearly illustrate various layers and regions. Like reference numbers may refer to like elements throughout the drawings and the following description. It will be understood that when one element, layer, film, section, sheet, etc. is referred to as being “on” another element, it can be directly on the other element or intervening elements may be present therebetween. Although the terms “first,” “second,” etc. may be used herein to describe various elements, these elements should not be limited by these terms. These terms are only used to distinguish one element from another element.

The term “average particle diameter (D50) value” as used herein refers to a particle size value corresponding to 50% from the smallest particle when the total number of particles is 100% in a distribution curve accumulated in order from the smallest particle size to the largest particle size. The average particle diameter D50 value may be measured by a method well known to those skilled in the art, and for example, may be also measured by using a particle size analyzer or through a TEM or SEM image. Alternatively, after measuring with a measuring device using dynamic light-scattering, performing data analysis, counting the number of particles for each particle size range, and then calculating, the average particle diameter D50 value may be easily obtained.

In general, as a separator for a lithium secondary battery, coated separators in which inorganic particles and binders are coated on a substrate to improve heat resistance and safety are being developed. Such a coated separator is mostly one layer, and thus it is difficult to implement effective adhesion between the separator and electrodes. Also, when inorganic particles and binders are coated simultaneously and consecutively in two layers on a substrate, a uniform coating of a binder slurry which is in an aqueous solution state is difficult to carry out on a wet coating layer of inorganic particles.

In order to solve this problem, the inventors of the present disclosure are to suggest a separator for a lithium secondary battery as described below, a lithium secondary battery including the same, and a method of preparing the separator.

A separator for a lithium secondary battery according to an embodiment includes: a substrate; a first layer disposed on at least one surface of the substrate and including inorganic particles; and a second layer disposed on the first layer and consisting of polymer binder particles, wherein an average particle diameter D50 of the inorganic particles is less than 300 nm, and an average particle diameter D50 of the polymer binder particles is 200 nm to 500 nm. The average particle diameter D50 of the polymer binder particles may be 200 nm to 450 nm or 200 nm to 400 nm. When the average particle diameter D50 of the inorganic particles and the average particle diameter D50 of the polymer binder particles are within this range, the content of the polymer binder particles of the second layer that have penetrated into the inorganic particles of the first layer may be reduced by reducing surface roughness of the first layer including the inorganic particles and improving packing density of the first layer. Therefore, the separator may solidly implement the first layer including the inorganic particles, and accordingly, the interface between the first layer and the second layer may be clearly separated on at least one surface of the substrate, thereby enabling a uniform coating.

A thickness of the first layer may be 1.5 μm to 4.0 μm. A thickness of the second layer may be 1.0 μm to 3.0 μm. When having the thicknesses of the first layer and the second layer within these ranges, the adhesion between the separator and the electrodes may be improved, and thus the separator may have improved bending strength. Due to thin-film thicknesses of the first layer and the second layer, a capacity per volume of the lithium secondary battery may be maximized.

The surface roughness (Ra) of the first layer may be 70 nm or less. The surface roughness Ra of the first layer may be 65 nm or less, 60 nm or less, or 55 nm or less. When the surface roughness Ra of the first layer is reduced to the range above, a content of the binder particles penetrating among the inorganic particles may be minimized. The polymer binder particles of the second layer that have penetrated into the inorganic particles of the first layer may penetrate to a depth of 0.5 μm or less in a direction of the substrate from an interface between the first layer and the second layer. When the depth of the polymer binder particles of the second layer that have penetrated into the inorganic particles of the first layer is reduced to the range above, the packing density of the first layer including the inorganic particles may be improved, thereby implementing a solidified layer including the inorganic particles.

The inorganic particles may include at least one selected from alumina (Al₂O₃), boehmite, BaSO₄, MgO, Mg(OH)₂, clay, silica (SiO₂), TiO₂, SnO₂, CeO₂, NiO, CaO, ZnO, ZrO₂, Y₂O₃, SrTiO₃, BaTiO₃, and MgF₂. One type of the inorganic particles may be used alone, or two or more types of the inorganic particles may be used in combination. For example, the inorganic particles may include alumina (Al₂O₃), boehmite, or Mg(OH)₂. The inorganic particles may be in the form of spheres, plates, fibers, or the like, but are not limited thereto. Any form usable in the art may be used. For example, when the inorganic particles are in the form of plates, reduction of a separator area at high temperatures may be further suppressed, relatively high porosity may be secured, and characteristics of the lithium secondary battery evaluated during penetration may be improved.

The polymer binder particles may include an acrylate-based binder, a fluorine-based binder, a rubber-based binder, a cellulose-based binder, or a combination thereof. The polymer binder particles may enhance adhesion with the inorganic particles. Examples of the acrylate-based binder may include polymethylmethacrylate, polybutylacrylate, and the like. Examples of the fluorine-based binder may include polyvinylidene fluoride, a polyvinylidene fluoride-co-hexafluoropropylene copolymer, a polyvinylidene fluoride-co-trichloroethylene copolymer, and the like. Examples of the rubber-based binder may include a styrenebutadiene copolymer, an acrylonitrile styrenebutadiene copolymer, and the like. Examples of the cellulose-based binder may include cellulose acetate, cellulose acetate butyrate, cellulose acetate propionate, cyanoethylcellulose, carboxyl methyl cellulose, and the like. For example, the polymer binder particles may include, as a fluorine-based binder, polyvinylidene fluoride, a polyvinylidene fluoride-co-hexafluoropropylene copolymer, and the like. A weight average molecular weight (Mw) of the fluorine-based binder may be in a range of 300,000 g/mol to 1,700,000 g/mol. When the fluorine-based binder is used within the molecular weight range, the adhesion between the substrate and the first layer and second layer may be strengthened, thereby effectively suppressing heat-induced shrinkage of the substrate that is heat-vulnerable. Also, the separator may be prepared with sufficiently improved impregnation of electrolyte, and used to prepare a battery that outputs electricity efficiently.

The substrate may be a porous substrate. The porous substrate may be a porous film including a polyolefin. A polyolefin has an excellent short-circuit prevention effect, and may also improve battery stability by this shutdown effect. For example, the porous substrate may be a film consisting of resins of a polyolefin or a mixture or copolymer thereof, the polyolefin including polyethylene, polypropylene, polybutene, polyvinyl chloride, or the like, but embodiments are not limited thereto. Any porous film available in the art may be used. For example, a porous film consisting of polyolefin-based resins; a porous film woven with polyolefin-based fibers; a nonwoven fabric including a polyolefin; an aggregate of particles of insulating materials; or the like may be used. For example, a porous film including a polyolefin may provide excellent coating ability for a binder solution used to prepare a coating layer formed on the substrate, and by thinning a film thickness of the separator, the ratio of active materials in the battery may be increased, thereby increasing the capacity per unit volume.

For example, a polyolefin used as a material for a porous substrate may include a homopolymer, a copolymer, or a mixture thereof of polyethylene, polypropylene, or the like. Polyethylene may be low-density, medium-density, or high-density polyethylene, and in terms of mechanical strength, high-density polyethylene may be used. Also, two or more types of polyethylene may be mixed for the purpose of providing flexibility. A polymerization catalyst used to prepare polyethylene is not particularly limited, and for example, a Ziegler-Natta type catalyst, a Phillips type catalyst, a metallocene type catalyst, or the like may be used. In terms of achieving both mechanical intensity and high permeability, the weight average molecular weight Mw of the polyethylene may be 100,000 g/mol to 12 million g/mol, for example, 200,000 g/mol to 3 million g/mol. The polypropylene may be a homopolymer, a random copolymer, or a block copolymer, and may be used alone or in a mixture of two or more types thereof. Also, the polymerization catalyst is not particularly limited, and for example, a Ziegler-Natta type catalyst, a metallocene catalyst, or the like may be used. Also, stereoregularity of the polypropylene is not particularly limited, and for example, isotactic, syndiotactic, or atactic propylene may be used. Also, within a range that does not impair the effects of the present disclosure, additives, such as polyolefins other than polyethylene or polypropylene and antioxidants may be added to the polyolefin.

For example, the porous substrate may include the polyolefin such as polyethylene, polypropylene, or the like, and may be used as a multilayer film of two or more layers. For example, a mixed multilayer film, such as a two-layer separator of polyethylene/polypropylene, a three-layer separator of three-layer separator polyethylene/polypropylene/polyethylene, a of polypropylene/polyethylene/polypropylene, or the like, may be used, but embodiments are not limited thereto. Any material and configuration available as a porous substrate may be used.

For example, the porous substrate may include a diene-based polymer prepared by polymerizing a monomer composition including a diene-based monomer. The diene-based monomer may be a conjugated diene-based monomer or a non-conjugated diene-based monomer. For example, the diene-based monomer may include at least one selected from 1,3-butadiene, isoprene, 2-chloro-1,3-butadiene, 2,3-dimethyl-1,3-butadiene, 2-ethyl-1,3-butadiene, 1,3-pentadiene, chloroprene, vinylpyridine, vinylnorbornene, dicyclopentadiene, and 1,4-hexadiene, but embodiments are not limited thereto. Any material available in the art as a diene-based monomer may be used.

In the separator, a thickness of the porous substrate may be 1 μm to 100 μm. For example, the thickness of the porous substrate may be 1 μm to 30 μm. For example, the thickness of the porous substrate may be 5 μm to 20 μm. For example, the thickness of the porous substrate may be 5 μm to 15 μm. For example, the thickness of the porous substrate may be 5 μm to 10 μm. When the thickness of the porous substrate is less than 1 μm, it may be difficult to maintain the mechanical properties of the separator, and when the thickness of the porous substrate is more than 100 μm, the internal resistance of the lithium secondary battery may increase.

In the separator, a porosity of the porous substrate may be 5% to 95%. When the porosity is less than 5%, the internal resistance of the lithium secondary battery may increase, and when the porosity is more than 95%, it may be difficult to maintain the mechanical properties of the porous substrate.

In the separator, a pore size of the porous substrate may be 0.01 μm to 10 μm. For example, in the separator, the pore size of the porous substrate may be 0.01 μm to 5 μm. For example, in the separator, the pore size of the porous substrate may be 0.01 μm to 1 μm. When the pore size of the porous substrate is less than 0.01 μm, the internal resistance of the lithium secondary battery may increase, and when the pore size of the porous substrate is more than 10 μm, it is difficult to maintain the mechanical properties of the porous substrate.

Also, depending on the selection of those skilled in the art, general additives for the purpose of improving specific functions, such as a plasticizer, an oxidation stabilizer, a UV stabilizer, an antistatic agent, or the like, may be added to the porous substrate.

A lithium secondary battery according to another embodiment may include: a positive electrode including a positive electrode active material; a negative electrode including a negative electrode active material; and the separator disposed between the positive electrode and the negative electrode. Since the lithium secondary battery includes the separator, the adhesion between the separator and the electrodes may be improved, thereby improving bending strength.

The bending strength of the lithium secondary battery may be 400 N or more. For example, the bending strength of the lithium secondary battery may be 405 N or more or 410 N or more.

A thickness of the separator may be 5 μm to 15 μm.

The positive electrode may be, for example, prepared according to the following method, but the preparation method is not necessarily limited thereto and may be adjusted to required conditions.

First, a positive electrode active material composition may be prepared by mixing the aforementioned positive electrode active material, a conductive material, a binder, and a solvent. The prepared positive electrode active material composition may be directly coated and dried on an aluminum current collector to form a positive electrode plate provided with a positive electrode active material layer. Alternatively, a film obtained by casting the positive electrode active material composition on a separate support and separating it from the support may be laminated on an aluminum current collector to prepare a positive electrode plate on which the positive electrode active material layer is formed.

Examples of the conductive material may be: carbon black, graphite particulates, natural graphite, artificial graphite, acetylene black, ketjen black, carbon fibers; carbon nanotubes; metallic powder, metallic fiber, or metallic tube of copper, nickel, aluminum, silver, and the like; and a conductive polymer such as a polyphenylene derivative. However, embodiments are not limited thereto, and any suitable conductive material available in the art may be used.

Examples of the binder are a vinylidene fluoride/hexafluoropropylene copolymer, polyvinylidene fluoride, polyacrylonitrile, polymethyl methacrylate, polytetrafluoroethylene (PTFE), a mixture of the aforementioned polymers, a styrene butadiene-rubber polymer, and the like, and examples of the solvent are N-methyl pyrrolidone (NMP), acetone, water, and the like. However, embodiments are not limited thereto, and any binder and solvent available in the art may be used.

By further adding a plasticizer or a pore former to the positive electrode active material composition, pores may be formed inside an electrode plate.

The contents of the positive electrode active material, the conductive material, the binder, and the solvent used in the positive electrode may be at levels general for use in a lithium battery. Depending on the use and configuration of the lithium battery, one or more of the conductive material, the binder, and the solvent may be omitted.

The positive electrode active material may be a lithium-containing metal oxide, and any material available in the art may be used. For example, at least one composite oxide of lithium and a metal selected from Co, Mn, Ni, and a combination thereof may be used, and a specific example thereof may be a compound represented by one of the following formulae: LiₐA_{1-b}B′_{b}D′₂ (where 0.90≤a≤1 and 0≤b≤0.5); LiₐE_{1-b}B′_{b}O_{2-c}D′_{c} (where 0.90≤a≤1, 0≤b≤0.5, and 0≤c≤0.05); LiE_{2-b}B′_{b}O_{4-c}D′_{c} (where 0≤b≤0.5 and 0≤c≤0.05); LiₐNi_{1-b-c}Co_{b}B′_{c}D′_{α} (where 0.90≤a≤1, 0≤b≤0.5, 0≤c≤0.05, and 0<α≤2); LiₐNi_{1-b-c}Co_{b}B′_{c}O_{2-α}F′_{α} (where 0.90≤a≤1, 0≤b≤0.5, 0≤c≤0.05, and 0<α<2); LiₐNi_{1-b-c}Co_{b}B′_{c}O_{2-α}F′₂ (where 0.90≤a≤1, 0≤b≤0.5, 0≤c≤0.05, and 0<α<2); LiₐNi_{1-b-c}Mn_{b}B′_{c}D′_{α} (where 0.90≤a≤1, 0≤b≤0.5, 0≤c≤0.05, and 0<α≤2); LiₐNi_{1-b-c}Mn_{b}B′_{c}O_{2-α}F′_{α} (where 0.90≤a≤1, 0≤b≤0.5, 0≤c≤0.05, and 0<α<2); LiₐNi_{1-b-c}Mn_{b}B′_{c}O_{2-α}F′₂ (where 0.90≤a≤1, 0≤b≤0.5, 0≤c≤0.05, and 0<α<2); LiₐNi_{b}E_{c}G_{d}O₂ (where 0.90≤a≤1, 0≤b≤0.9, 0≤c≤0.5, and 0.001≤d≤0.1.); LiₐNi_{b}Co_{c}Mn_{d}GeO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); LiₐMnG_{b}O₂ (where 0.90≤a≤1 and 0.001≤b≤0.1); LiₐMn₂G_{b}O₄ (where 0.90≤a≤1 and 0.001≤b≤0.1); QO₂; QS₂; LiQS₂; V₂O₅; LiV₂O₅; LiI′O₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae above representing the compound, A may be Ni, Co, Mn, or a combination thereof; B′ may be Al, Ni, Co, Mn, Cr, Fe, Mg, Sr, V, a rare earth element, or a combination thereof; D′ may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof.

A compound in which a coating layer is additionally provided on the surface of the aforementioned compound may be also used, and a mixture of the aforementioned compound and a compound additionally provided with a coating layer may be also used. The coating layer additionally provided on the surface of the aforementioned compound may include, for example, a coating element compound, such as an oxide of a coating element, a hydroxide of a coating element, oxyhydroxide of a coating element, oxycarbonate of a coating element, or hydroxycarbonate of a coating element. The compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. A method of forming the coating layer may be selected within a range that does not adversely affect the physical properties of the positive electrode active material. The coating method may be, for example, spray coating, dipping method, or the like. A detailed description of the coating method will be omitted because it may be well understood by those in the art.

Next, a negative electrode may be prepared as follows. The negative electrode may be, for example, prepared in the same manner as in the positive electrode, except that the aforementioned negative electrode active material is used instead of the positive electrode active material. In addition, in the negative electrode active material composition, the substantially same conductive material, binder, and solvent as those used in the positive electrode preparation may be used.

For example, a negative electrode active material, a conductive material, a binder, and a solvent may be mixed to prepare a negative electrode active material composition. The negative electrode active material composition may be then directly coated on a copper current collector to prepare a negative electrode plate. Alternatively, a negative electrode active material film obtained by casting the negative electrode active material composition on a separate support and separating it from the support may be laminated on a copper current collector to prepare a negative electrode plate.

As the negative electrode active material, any suitable negative electrode active material available in the art for a lithium battery may be used. For example, the negative electrode active material may include at least one selected from lithium metal, a metal alloyable with lithium, a transition metal oxide, a non-transition metal oxide, and a carbon-based material.

Examples of the metal alloyable with lithium are Si, Sn, Al, Ge, lead (Pb), Bi, Sb), a Si—Y′ alloy (where Y′ is an alkali metal, an alkaline earth metal, a Group 13 element, a Group 14 element, a transition metal, a rare earth element, or a combination thereof, and Y′ is not Si), and a Sn—Y′ alloy (wherein Y′ is an alkali metal, an alkaline earth-metal, a Group 13 element, a Group 14 element, a transition metal, a rare earth element, or a combination thereof, and Y′ is not Sn). The element Y′ may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include, for example, a lithium titanium oxide, a vanadium oxide, a lithium vanadium oxide, and the like.

The non-transition metal oxide may be, for example, SnO₂, SiOx (where 0<x<2), and the like.

The carbon-based material may be, for example, crystalline carbon, amorphous carbon, or a mixture thereof. The crystalline carbon may be, for example, amorphous, plate-like, flake-like, spherical, or fibrous graphite, such as natural graphite or artificial graphite. The amorphous carbon may be, for example, soft carbon (carbon sintered at a low temperature) or hard carbon, mesophase pitch carbide, sintered coke, and the like.

The contents of the negative electrode active material, the conductive material, the binder, and the solvent may be at levels general for use in a lithium battery. Depending on the use and configuration of the lithium battery, one or more of the conductive material, the binder, and the solvent may be omitted.

Next, a separator to be inserted between the positive electrode and the negative electrode is prepared.

For use as a separator, the aforementioned separator may be used. A preparation method of the separator will be described below.

Next, an electrolyte is prepared.

The electrolyte may be, for example, an organic electrolyte solution. The organic electrolyte solution may be, for example, prepared by dissolving a lithium salt in an organic solvent.

For use as the organic solvent, any suitable organic solvent available in the art may be used. Examples of the organic solvent are propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, methylpropionate, ethylpropionate, propylpropionate, benzonitrile, acetonitrile, tetrahydrofuran, 2-methyl tetrahydrofuran, γ-butyrolactone, dioxolan, 4-methyl dioxolan, N,N-dimethyl formamide, dimethyl acetamide, dimethyl sulfoxide, dioxane, 1,2-dimethoxyethane, sulfolane, dichloroethane, chlorobenzene, nitrobenzene, diethylene glycol, dimethyl ether, or a mixture thereof.

For use as the lithium salt, any material available in the art as a lithium salt may be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(where x and y may each be a natural number), LiCl, LiI, or a mixture thereof.

Alternatively, the electrolyte may be a solid electrolyte. The solid electrolyte may be, for example, boron oxide, lithium oxynitride, and the like, but embodiments are not limited thereto. Any suitable solid electrolyte available in the art may be used. The solid electrolyte may be formed on the negative electrode by a method such as sputtering, or a separate solid electrolyte sheet may laminated on the negative electrode.

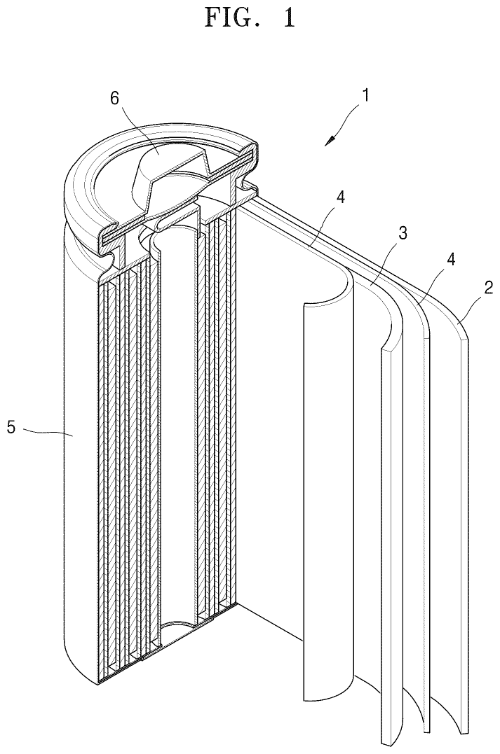

As shown in FIG. 1, a lithium secondary battery 1 includes a positive electrode 3, a negative electrode 2, and a separator 4. The positive electrode 3, the negative electrode 2, and the separator 4 may be wound or folded to be accommodated in a battery case 5. Then, the battery case 5 may be filled with an organic electrolyte solution, and sealed with a cap assembly 6, thereby completing the manufacture of the lithium secondary battery 1. The battery case 5 may be cylindrical, but the shape of the battery case 5 is not necessarily limited thereto. For example, the battery case 5 may be a square-type, a thin-film type, a pouch-type, or the like.

The pouch-type lithium secondary battery may include at least one battery assembly. The separator 4 may be disposed between the positive electrode 3 and the negative electrode 2 to form a battery assembly. The battery assembly may be laminated as a bi-cell structure, impregnated with an organic electrolyte solution, and accommodated and sealed in a pouch, thereby completing the manufacture of a pouch-type lithium battery. Multiple battery assemblies are stacked to form a battery pack, and the battery pack may be used in all types of devices requiring high capacity and high output. For example, the pouch-type lithium secondary battery may be used in a laptop computer, a smart phone, an electronic vehicle, or the like.

Since the lithium secondary battery has excellent lifespan characteristics and excellent high-rate characteristics, the lithium secondary battery may be used in, for example, an electric vehicle (EV). For example, the lithium secondary battery may be used in a hybrid vehicle, such as a plug-in hybrid electric vehicle (PHEV). In addition, the lithium secondary battery may be applicable to the fields requiring high-power storage. For example, the secondary lithium battery may be used in an electric bicycle, a power tool, or the like.

A method of preparing the separator according to an embodiment includes: preparing a substrate; preparing a first composition including inorganic particles having an average particle diameter D50 of less than 300 nm; preparing a second composition including polymer binder particles having an average particle diameter D50 of 200 nm to 500 nm; forming a first layer including the inorganic particles by coating at least one surface of the substrate with the first composition; and preparing a second layer including the polymer binder particles by coating one surface of the first layer with the second composition to thereby form the separator.

The substrate may be a porous film including a polyolefin. The porous film including a polyolefin is the same as described above, and thus a description thereof will be omitted.

The first composition including the inorganic particles may be used in the form of an inorganic dispersion in which the inorganic particles having an average particle diameter D50 of 300 nm less are dispersed in an appropriate solvent. The inorganic dispersion may be dispersed by using a ball mill, a bead, and/or a screw mixer. The appropriate solvent is not particularly limited, and any solvent commonly used in the art may be used. The solvent used may be an aqueous solvent. The aqueous solvent contains more than 50 wt % of water as a main component, and may additionally contain other polar solvents. The polar solvent is not particularly limited as long as it is a solvent that is well miscible with water and available in the art. For example, the polar solvent may be methanol, ethanol, polyvinyl alcohol, and the like. If necessary, the first composition including the inorganic particles may additionally include an anionic polymer dispersant as an aqueous dispersant. The anionic polymer dispersant is included in a small content in the first composition so that a low-viscosity slurry composition may be prepared in a short time. An example of the anionic polymer dispersant may be ammonium polycarbonate.

A solids content of the first composition may be 40 wt % to 50 wt % based on a total of 100 wt %. When having the solids content of the first composition within the range above, the surface roughness of the first composition including the inorganic particles may be reduced, and accordingly, the content of the polymer binder particles of the second layer that have penetrated into the inorganic particles of the first layer may be also reduced. Therefore, the separator may solidly implement the first layer including the inorganic particles, and in this regard, the interface between the first layer and the second layer may be clearly separated on at least one surface of the substrate, thereby enabling uniform coating.

The surface roughness Ra of first layer may be 70 nm or less.

The polymer binder particles included in the second composition may be those having an average particle diameter D50 of 200 nm to 500 nm, and for example, may include fluorine-based binder latex particles. For example, the fluorine-based binder latex particles may include polyvinylidene fluoride-co-hexafluoropropylene copolymer latex particles. The fluorine-based binder latex particles may be semi-crystalline fluoropolymers, and may be prepared by an emulsion polymerization process. Such semi-crystalline fluorine-based binder latex particles prepared by an emulsion polymerization process may be provided in the form of fine particles with a smaller average particle diameter D50 than those prepared by a suspension polymerization process. These fluorine-based binder latex particles in the form of fine particles may improve adhesion to the inorganic particles. Also, when having the average particle diameter D50 of the fluorine-based binder latex particles within the range above, a composition having excellent water dispersion characteristics and excellent affinity with the first layer including the inorganic particles may be prepared. Due to these characteristics, the separator prepared through coating and drying processes may exhibit an effect of improving the adhesion to the electrodes. A weight average molecular weight Mw of the fluorine-based binder latex particles may be 500,000 g/mol to 1,000,000 g/mol, for example 400,000 g/mol to 600,000 g/mol. When having the weight average molecular weight Mw within the ranged above, in the preparation of fine particles by an emulsion polymerization process, the fine particles may have an appropriate average particle diameter to have excellent characteristics for water dispersion. If necessary, the second composition including the polymer binder particles may further include additives such as a leveling agent. An example of the leveling agent may include a polysiloxane-based compound.

The first layer including the inorganic particles may be formed by coating at least one surface of the substrate with the first composition. The second layer including the polymer binder particles may be formed by coating and drying one surface of the first layer with the second composition to form the aforementioned separator for the lithium secondary battery. The forming of the first layer and the forming of the second layer may be performed simultaneously and continuously. The method of coating the substrate with the first composition and second composition is not particularly limited, and methods commonly used in the art may be used. Examples of the coating method may include a dip-coating method, a die-coating method, a roll-coating method, a comma-coating method, a gravure-coating method, and the like, but embodiments are not limited thereto. These methods may be applied alone or in combination of two or more types. Both the first layer and the second layer may be formed by, for example, a gravure-coating method.

A thickness of the first layer may be 1.5 μm to 4.0 μm, and a thickness of the second layer may be 1.0 μm to 3.0 μm. When having the thicknesses of the first layer and the second layer within these ranges, the adhesion between the separator and the electrodes may be improved, and thus the separator may have improved bending strength. Due to thin-film thicknesses of the first layer and the second layer, the capacity per volume of the lithium secondary battery may be maximized.

The first layer and the second layer may be dried by using warm air, hot air, or low-humidity air, or by vacuum drying or irradiation with far-infrared rays or electron beams. The drying temperature may vary depending on types of a solvent, but the drying may be performed at a temperature of 60° C. to 120° C. The drying time may also vary depending on types of a solvent, but the drying may be usually performed for 1 minute to 1 hour.

The present disclosure is in greater details through Examples and Comparative Examples below. However, the following embodiments are for illustrative purpose only and shall not be construed as limiting the scope of the present disclosure.

### EXAMPLES

### Preparation of Separator

### Example 1

### (First Composition Including Inorganic Particles)

Alumina (Al₂O₃) having an average particle diameter D50 of 200 nm was added to 50 wt % ultrapure water, and an anionic polycarboxylic acid ammonium additive (ELEXCEL-DS 540, San Nopco Korea Ltd.) was added thereto at 2 wt % based on a solids content of an inorganic particle dispersion, followed by stirring for 1 hour to prepare a mixed solution. The mixed solution was subjected to milling in a bead mill using 300-μm-sized beads for about 2 hours for dispersion to prepare a dispersion containing inorganic particles. After adding polyvinyl alcohol at 2 wt % based on a solids content of the dispersion containing inorganic particles, the resulting solution was stirred for 1 hour to prepare a first composition including inorganic particles.

### (Second Composition Including Polymer Binder Particles)

A water dispersion latex of PVdF-HFP polymer (having a molar ratio of PVdF:HFP=98:2, glass transition temperature: −30° C., melting point: 150° C., and average particle diameter D50: 200 nm) was diluted with ultrapure water to have a solids content of 5 wt %, and polyether-modified polysiloxane as a leveling agent was added thereto at 2 wt % based on a solids content. The mixed solution was then stirred for 4 hours to prepare a second composition including polymer binder particles.

### (Separator)

The first composition including inorganic particles was coated on one surface of a 7.0 μm-thick polyethylene substrate film (manufactured by SK Innovation) according to a gravure coating method, and the second composition including polymer binder particles was then continuously coated thereon through a slot die having a shim thickness of 75 μm. Next, the surface on which the first composition and the second composition were coated was dried at a running speed of 20 mpm and a temperature of 75° C. to prepare a separator in which a first layer including the inorganic particles and a second layer including the polymer binder particles were formed in sequence on one surface of the polyethylene substrate film. The first layer including the inorganic particles had a thickness of 1.5 μm, and the second layer including the polymer binder particles had a thickness of 1.0 μm.

### Example 2

A separator was prepared in the same manner as in Example 1, except that a first composition including a mixed solution and inorganic particles was prepared by adding 40 wt % of alumina (Al₂O₃) having an average particle diameter D50 of 200 nm to ultrapure water.

### Example 3

A separator was prepared in the same manner as in Example 1, except that a second composition including polymer particles was prepared by using a water dispersion latex of a PVdF-HFP polymer having an average particle diameter D50 of 500 nm was used instead of the water dispersion latex of the PVdF-HFP polymer having an average particle diameter D50 of 200 nm.

### Example 4

A separator was prepared in the same manner as in Example 1, except that a first layer including inorganic particles had a thickness of 4.0 μm.

### Example 5

A separator was prepared in the same manner as in Example 1, except that a first composition including a mixed solution and inorganic particles was prepared by adding 40 wt % of alumina (Al₂O₃) having an average particle diameter D50 of 200 nm to ultrapure water, and that a second including polymer binder particles had a thickness of 3.0 μm.

### Comparative Example 1

A separator was prepared in the same manner as in Example 1, except that a first composition including a mixed solution and inorganic particles was prepared by using alumina (Al₂O₃) having an average particle diameter D50 of 450 nm.

### Comparative Example 2

A separator was prepared in the same manner as in Example 1, except that a first composition including a mixed solution and inorganic particles was prepared by using alumina (Al₂O₃) having an average particle diameter D50 of 650 nm.

### Comparative Example 3

A separator was prepared in the same manner as in Example 1, except that a first composition including a mixed solution and inorganic particles was prepared by using alumina (Al₂O₃) having an average particle diameter D50 of 310 nm.

### (Preparation of Lithium Secondary Battery)

### Example 6

### (Preparation of Negative Electrode)

97 wt % of graphite particles having an average particle diameter D50 of 25 μm, 1.5 wt % of styrene-butadiene rubber (SBR) as a binder, and 1.5 wt % of carboxymethylcellulose (CMC) were mixed and added to distilled water, and the mixed solution was stirred with a mechanical stirrer for 60 minutes to prepare a negative electrode active material slurry. The negative electrode active material slurry was applied to a 10 μm-thick copper current collector by using a doctor blade, dried in a hot-air dryer at 100° C. for 0.5 hour, dried again in a vacuum condition at 120° C. for 4 hours, and then roll-pressed to prepare a negative electrode plate.

### (Preparation of Positive Electrode)

97 wt % of LiCoO₂, 1.5 wt % of carbon black powder as a conductive material, and 1.5 wt % of polyvinylidenefluoride (PVdF) were mixed and added to an N-methyl-2-pyrrolidone solvent, and the mixed solution was stirred with a mechanical stirrer for 30 minutes to prepare a positive electrode active material slurry. The positive electrode active material slurry was applied to a 20 μm-thick aluminum current collector by using a doctor blade, dried in a hot-air dryer at 100° C. for 0.5 hour, dried again in a vacuum condition at 120° C. for 4 hours, and then roll-pressed to prepare a positive electrode plate.

### (Preparation of Lithium Secondary Battery)

A jelly roll with the separator of Example 1 between the positive electrode plate and the negative electrode plate was inserted into a pouch, and an electrolyte solution was injected thereto. The pouch was then vacuum-sealed and subjected to thermal pressing at 85° C. for 3 minutes while applying a load of 450 kgf.

For use as the electrolyte solution, a solution in which 1.3M LiPF₆ was dissolved in a mixed solvent of ethylene carbonate (EC), propylene carbonate (PC), ethyl propionate (EP), and propyl propionate (PP) (in a volume ratio of 15:15:25:45) was used.

### Examples 7 to 10

Lithium secondary batteries were prepared in the same manner as in Example 6, except that the separators of Examples 2 to 5 were used respectively, instead of the electrolyte of Example 1.

### Comparative Examples 4 to 6

Lithium secondary batteries were prepared in the same manner as in Example 6, except that the separators of Comparative Examples 1 to 3 were used respectively, instead of the electrolyte of Example 1.

### Evaluation Example 1: Surface Roughness (Ra) of First Layer and Field Emission-Scanning Electron Microscope (FE-SEM)

### (1) Surface Roughness Ra of First Layer

The surface roughness Ra of the first layer including the inorganic particles of the separators of Examples 1 to 5 and Comparative Examples 1 to 3 was measured by using an atomic force microscope. Results thereof are shown in Table 1.

### (2) Field Emission-Scanning Electron Microscope (FE-SEM)

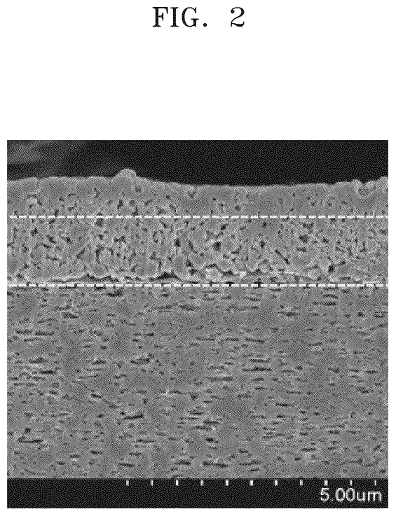

Cross-sections of each of the separators of Examples 1 to 5 and Comparative Examples 1 to 3 were cut and subjected to FE-SEM analysis. Results thereof are shown in Table 1 and FIG. 2. The FE-SEM analysis was performed at a magnification of 10 K, and the depth of penetration of the polymer binder particles of the second layer into the inorganic particles of the first layer was measured in a direction of the substrate from an interface between the first layer and the second layer.

TABLE 1

| | Surface | Depth (μm) of penetration of |
|---|---|---|
| | roughness of | polymer binder particles of |
| | first layer | second layer into inorganic |
| | (Ra, nm) | particles of first layer |
| Example 1 | 42 | 0.2 |
| Example 2 | 52.5 | 0.3 |
| Example 3 | 43.5 | 0.4 |
| Example 4 | 42 | 0.2 |
| Example 5 | 52.5 | 0.5 |
| Comparative Example 1 | 129 | 0.7 |
| Comparative Example 2 | 162 | 1.0 |
| Comparative Example 3 | 109 | 0.7 |

Referring to Table 1, the separators of Examples 1 to 5 had the surface roughness Ra of 52.5 nm or less for the first layer including the inorganic particles, and the depth of penetration of the polymer binder particles of the second layer into the inorganic particles of the first layer was 0.5 μm or less in total. The separators of Examples 1 to 5 showed decreases in both the surface roughness Ra for the first layer including inorganic particles and the depth of penetration of the polymer binder particles of the second layer into the inorganic particles of the first layer, compared to the separators of Comparative Examples 1 to 3.

Also, referring to FIG. 2, in the separator of Example 1, the interface between the first layer including the inorganic particles and the second layer including the polymer binder particles can be seen as being clearly separated on the substrate film. It was confirmed that the polymer binder particles of the second layer that have penetrated into the inorganic particles of the first layer penetrated to a depth of about 0.2 μm in the substrate direction from the interface between the first layer and the second layer.

Accordingly, it was confirmed that the separators of Examples 1 to 5 were able to form a stronger first layer than the separators of Comparative Examples 1 to 3, enabling uniform coating.

### Evaluation Example 2: Bending Strength

For the lithium secondary batteries of Examples 6 to 10 and Comparative Examples 4 to 6, the bending I strength was measured by using a three-point bending analyzer. Results thereof are shown in Table 2.

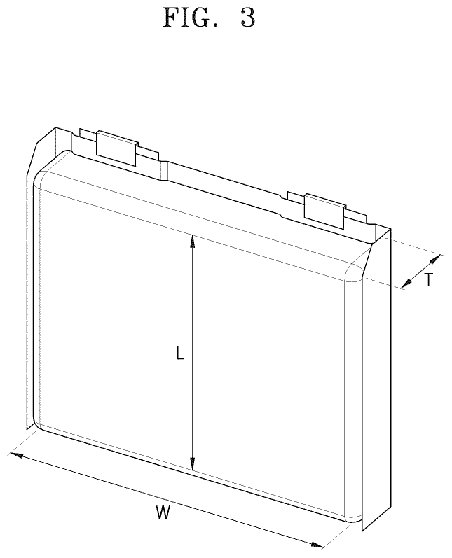

The device used to analyze the bending strength was Single column (Instron-3344). A lithium secondary battery sample was prepared with a size of, based on the length (L), width (W), and thickness (T) of FIG. 3, 60 mm (L)×60 mm (W)×5.0 mm (T). The lithium secondary battery sample was charged at a constant current of 0.7 C rate at 25° C. until a voltage reached 4.40 V within a cut-off range of 0.05 C, followed by discharging until a voltage reached 3.0 V with a cut-off range of 0.5 C. One cycle of such charging and discharging was repeated up to 10 cycles, and then the bending strength was evaluated in the discharged state.

The bending strength was evaluated as follows.

After placing the midpoint of the length L of the lithium secondary battery sample at the exact center of the span of the bending strength analyzer, a jig equipped with a load cell with a maximum load of 1 kN was pressed in the vertical direction at a speed of 5 mm/min, and the maximum strength of the lithium secondary battery sample when bent was measured.

TABLE 2

| | Bending strength (N) |
|---|---|
| Example 6 | 450 |
| Example 7 | 439 |
| Example 8 | 413 |
| Example 9 | 459 |
| Example 10 | 480 |
| Comparative Example 4 | 356 |
| Comparative Example 5 | 333 |
| Comparative Example 6 | 364 |

Referring to Table 2, the lithium secondary batteries of Examples 6 to 10 showed improvement in the bending strength to be 400 N or more, compared to the lithium secondary batteries of Comparative Examples 4 to 6.

1. A separator for a lithium secondary battery, comprising:
a substrate;
a first layer disposed on at least one surface of the substrate and comprising inorganic particles; and
a second layer disposed on the first layer and comprising polymer binder particles, wherein
an average particle diameter (D50) of the inorganic particles is less than 300 nm, and an average particle diameter (D50) of the polymer binder particles is 200 nm to 500 nm.

2. The separator of claim 1, wherein a thickness of the first layer is 1.5 μm to 4.0 μm.

3. The separator of claim 1, wherein a thickness of the second layer is 1.0 μm to 3.0 μm.

4. The separator of claim 1, wherein a surface roughness (Ra) of the first layer is 70 nm or less.

5. The separator of claim 1, wherein the polymer binder particles of the second layer that have penetrated into the inorganic particles of the first layer penetrate to a depth of 0.5 μm or less in a direction of the substrate from an interface between the first layer and the second layer.

6. The separator of claim 1, wherein the inorganic particles comprise at least one selected from alumina (Al₂O₃), boehmite, BaSO₄, MgO, Mg(OH)₂, clay, silica (SiO₂), TiO₂, SnO₂, CeO₂, NiO, CaO, ZnO, ZrO₂, Y₂O₃, SrTiO₃, BaTiO₃, and MgF₂.

7. The separator of claim 1, wherein the polymer binder particles comprise an acrylate-based binder, a fluorine-based binder, a rubber-based binder, a cellulose-based binder, or a combination thereof.

8. A lithium secondary battery comprising:
a positive electrode comprising a positive electrode active material;
a negative electrode comprising a negative electrode active material; and
the separator according to claim 1 disposed between the positive electrode and the negative electrode.

9. The lithium secondary battery of claim 8, wherein a bending strength of the lithium secondary battery is 400 N or more.

10. A method of preparing a separator for a lithium secondary battery, the method comprising:
preparing a substrate;
preparing a first composition comprising inorganic particles having an average particle diameter (D50) of less than 300 nm;
preparing a second composition comprising polymer binder particles having an average particle diameter (D50) of 200 nm to 500 nm;
forming a first layer comprising the inorganic particles by coating at least one surface of the substrate with the first composition; and
forming a second layer comprising the polymer binder particles by coating one surface of the first layer with the second composition, to thereby prepare the separator according to claim 1.

11. The method of claim 10, wherein a solids content in the first composition is 40 wt % to 50 wt % based on a total of 100 wt %.

12. The method of claim 10, wherein a surface roughness (Ra) of the first layer is 70 nm or less.

13. The method of claim 10, wherein a thickness of the first layer is 1.5 μm to 4.0 μm, and a thickness of the second layer is 1.0 μm to 3.0 μm.
